(19) United States
(12) Patent Application Publication
(10) Pub. No.: US 2020/0367540 A1
(43) Pub. Date: Nov. 26, 2020

(54) Method for producing a reconstituted raw piece of meat

(71) Applicant: Reiner HAUF, Wien (DE)

(72) Inventor: Reiner HAUF, Wien (DE)

(21) Appl. No.: 16/992,314

(22) Filed: Aug. 13, 2020

Related U.S. Application Data
(63) Continuation-in-part of application No. 15/573,486, filed on Jan. 25, 2018.

(51) Int. Cl. A23L 13/60; A23B 4/03; A23L 13/50; A23L 13/40; A23P 30/10

(52) U.S. Cl. CPC A23L 13/67; A23B 4/03; A23L 13/52; A23V 2002/00; A23L 13/424; A23P 30/10; A23L 13/428

(57) ABSTRACT

A method for combining a slice of raw meat and a layer of reconstituted raw piece of meat to obtain a combined raw piece of reconstituted meat/meat.

Prior products have been rejected as disadvantageous because: they contain chemical additives such as aminases; they are expensive to produce; they have an inhomogeneous appearance; they tend to separate/disassemble into single components during handling, reducing their shelf-life.

Invention contains only glycerol and salt as binders; stabilizing and preserving are carried out in a single step by drying to a residual moisture of approx. 10%. The raw combination of reconstituted meat/meat has the optical appearance of pure meat, similar elasticity and a precisely adjusted residual juice content. Such a pet food snack can include all types of meat of respective prey animals and shows no tendency to separate, even when subjected to impact, pressure, or shock stresses in a loosely stacked bag package.

### TECHNICAL FIELD

The present invention relates to a method for producing a reconstituted raw piece of meat, more particularly a raw piece of meat for animal feed, as claimed in the generic portion of the independent claims. Reconstituted meat compositions are established for use as raw masses for reconstitutable meat products such as, for example, boiled sausages or pressed pulp. Such general mixtures are described, for example, in DD204 837 A1. Raw pieces of meat for animal feed composed of pure meat that is preserved with salt and adjusted with polyols such as glycerol to a specified residual moisture and juiciness have been known for some time.

### DESCRIPTION OF THE PRIOR ART

Generic reconstituted meat compositions contain a binder. For this purpose, DE 69737580 T2 proposes established mixtures with transglutaminase as a protein binder. WO 87/06432 A1 additionally proposes the use of humectants for adjusting the juiciness of reconstituted meat compositions to suitable levels. From U.S. Pat. No. 4,827,661 it is known to combine classical sausage or mixed-meat raw materials, containing fat, water and boilable binders with slices of meat, to obtain a combined product by concluding heat.

A drawback of established mixtures with such binders is that in the market, the term “transglutaminase” is associated with “chemistry,” thus making it virtually impossible to overcome the accompanying negative reaction of the customer. Such “formed meat” products are described, for example, in WO 2012/045003 A2. In this case, granulates and fine pieces of meat are reconstituted into a new, visually uniform spatial form and firmly bound to one another. The drawback of such composite products is that they do not have the same organoleptic properties as those of pure, solid meat, with the result that raw pieces of meat of this type for animal feed are rejected or consumed only in small amounts by animals with a sharp sense of smell and taste.

A further drawback is that although transglutaminases allow favorable binding of the parts in a reconstituted raw piece of meat, they do not allow the piece to be preserved or stabilized. Corresponding processing methods always provide for two steps, specifically reconstituting and structural stabilizing of a reconstituted raw piece of meat followed by preservation or stabilizing thereof.

A further drawback is that available reconstituted meat products have the optical appearance of sausage products of an unknown type that have been shredded to the finest degree possible; reconstituted meat products having a structure similar to that of finely shredded bologna or Gelbwurst pork and veal sausage are generally considered in the market and by customers to be products of inferior value. In this connection, US 20120237648 A1 proposes the method of irregular shredding of extruded reconstituted meat masses using a special device and providing them with flavorings and grill patterns in order to give the impression of hand-made foods. However, this does not overcome the drawback that the homogeneous cut surfaces of the finely shredded reconstituted mass continue to give the impression of meat products of uncertain composition. This gives rise to the problem of overcoming the corresponding prejudice in order to influence the buying behavior of the end consumer by means of factual information on ingredients as an objective decision-making aid. For this purpose, the inventors propose the process explained below and the reconstituted piece of meat made available by this process, which by means of an optically visible meat surface allows the general acceptance of the customer resulting from this design property.

A further drawback is that established, dried combinations of meat and reconstituted meat have to be packaged in rigid cans or containers, because the reconstituted meat tends to disassemble and/or separate from the meat. If put and shipped in a loosely stacked bag package the impacts, shocks and jolts during handling of said bag affect directly the contained goods, resulting in the disassembly and detachment of the reconstituted raw meat from the meat. The shelf-life of such a product is low because even the mechanical wear during arrangement and presentation promotes disassembly quickly renders such a product shabby, reducing customers' acceptance to naught; such products have to be replaced repeatedly, because they are quickly no longer vendible for optical reasons.

The purpose of the present invention is therefore to overcome the drawbacks of the prior art and to provide reconstituted raw meat products which allow acceptance despite containing a portion of finely and very finely shredded meat containing binders.

This object is achieved according to the features of the independent claims by means of a method for producing a reconstituted raw piece of meat and a combined raw piece of reconstituted meat/meat, especially a raw piece of meat for animal feed. Advantageous embodiments are described in the dependent claims and in the description below.

### SUMMARY OF THE INVENTION

According to the invention a method for producing a combination of raw reconstituted meat and raw meat, having increased shelf life in a loosely stacked bag package, has several method steps, wherein in step

a) a reconstituted meat composition for reconstitutable raw masses, comprising shredded meat and binders, consisting of the components
100 parts by weight of shredded animal meat,
0.1 to 20 parts by weight of sodium chloride,
0.01 to 10 parts by weight of binder consisting of glycerol,
0 to 10 parts by weight of additional plant or animal protein, and
up to 5 parts by weight of adjusting, auxiliary and
unavoidable accompanying substances of the components,
is provided;
in step b) a solid piece of meat is cut into slices of uniform thickness, the thickness varying +−4%, and
in step c) the slices are arranged lying flat, wherein
each of the slices lying flat provides an individual target surface for a reconstituted meat layer, wherein
in step d) the reconstituted meat layer is obtained by applying the meat composition of step a) to the target surface of step c) and in step e) drying the combination of reconstituted meat/meat to a residual moisture of approximately 10% is effected.

### DESCRIPTION OF THE INVENTION AND ADVANTAGEOUS FEATURES

According to the invention a method for producing a combination of raw reconstituted meat and raw meat, having increased shelf life in a loosely stacked bag package, has several method steps.

In step a) a reconstituted meat composition for reconstitutable raw masses, comprising shredded meat and binders, is provided; the composition consists of the components

100 parts by weight of shredded animal meat,
0.1 to 20 parts by weight of sodium chloride,
0.01 to 10 parts by weight of binder consisting of glycerol,
0 to 10 parts by weight of additional plant or animal protein, and
up to 5 parts by weight of adjusting, auxiliary and
unavoidable accompanying substances of the components.

Herein ‘shredded animal meat’ designates the shredded, minced or ground raw meat; ‘sodium chloride’ designates the respective salt in food-grade quality; glycerol designates the respective alcohol (i.e. 1,2,3-propane-triol) in food-grade quality; ‘plant or animal protein’ designates pure, natural proteins obtainable from plant or animal sources, that may complement the protein contained within the shredded meat or raw meat; ‘adjusting, auxiliary and unavoidable accompanying substances’ designating common and established materials associated with food-grade components (e.g. antidegradants, preserving gases, pH-adjusters etc.).

In step b) a solid piece of meat is cut into slices of uniform thickness, the thickness varying +−4%. An improved degree of uniformity promotes stability of the later product due to hogeneous stability of the sheer meat layer.

In step c) the slices are arranged lying flat, wherein each of the slices lying flat provides an individual target surface for a reconstituted meat layer. Horizontal arrangement allows automatic, optical assessment of target surfaces so that a machine may carry out the next step, which is . . .

step d), wherein the reconstituted meat layer is obtained by applying the meat composition of step a) to the target surface of step c).

In concluding step e) drying the combination of reconstituted meat/meat to a residual moisture of approximately 10% is effected. ‘approximately’ indicating the accuracy obtainable with established, industrial food-drying machines.

It is an important hallmark of the inventive method, that no further water is added. Addition of water is a typical hallmark of established recipes and requires binders, that bind the additional water within a coagulating network.

In a preferable embodiment the method comprises further measures and features. Thus a reconstituted meat composition can be applied to a target surface with a uniform layer thickness and dried. In this case, a solid piece of meat is first cut into slices, the slices are arranged lying flat, and each of the slices lying flat provides an individual target surface for a reconstituted meat layer. Furthermore, the reconstituted meat composition for reconstitutable raw masses comprising shredded meat and binders is characterized by comprising the following components: 100 parts by weight of shredded animal meat, 0.1 to 20 parts by weight of salt, 0.01 to 10 parts by weight of glycerol, 0 to 10 parts by weight of additional plant or animal protein-, and up to 2 parts by weight of adjusting and auxiliary substances and unavoidable accompanying substances of the components.

Preferably a combined raw piece of reconstituted meat/meat obtained by the method according to the invention is characterized in that the meat and shredded meat are composed of poultry meat.

In a preferable embodiment a raw piece of animal meat according to the invention has a layer of a reconstituted meat composition comprising shredded meat and binders, wherein in turn the reconstituted meat composition consists of the components
20 to 90 parts by weight of shredded meat,
0.001 to 20 parts by weight of sodium chloride,
0.01 to 10 parts by weight of glycerol,
0 to 10 parts by weight of plant or animal protein, and
up to 2 parts by weight of adjusting and auxiliary substances and unavoidable accompanying substances of the components, the raw piece of reconstituted meat/meat further comprises a slice of solid meat, wherein in turn
the shredded meat and solid meat are composed of slaughtered meat,
the layer thickness of the reconstituted meat layer is 0.1 cm to 2 cm and the thickness of the slices is 0.1 cm to 1 cm, wherein the thickness of the slices is a maximum of 70% of the layer thickness of the reconstituted meat layer,
in the raw piece of reconstituted meat/meat, the slice of solid meat is arranged with its upper side visible, and
the raw piece of reconstituted meat/meat was obtained by preparation of the meat layers, combining them with a suitable punched out reconstituted meat layer, and drying.

In contrast to the established prior art, polyalcohols without additional modification are used. The polyalcohol used is glycerol, a naturally occurring compound. A composition containing glycerol, which is taken as part of homeopathic drugs in aqueous formulations for boosting health and is known to the user from this application, is accepted by the customer in a correspondingly positive manner, thus preventing the rejection otherwise associated with the ingredient transglutaminase.

Within the meaning of the present description, “meat” refers to all tissues that can be derived from livestock and are consumable by the target group. Similar animal types are preferably selected for the various components of a composition so that the consumer can be advantageously informed in direct and concise fashion on the ingredients of the product using a generic term such as “poultry” or “beef.” It is particularly preferable in the case of animal feed products to use all of the tissue types of a prey animal species, preferably in physiologically suitable concentrations, in order to imitate as closely as possible the natural diet of a carnivorous animal to be fed: in this manner, all of the food components of the corresponding prey animal, such as, for example, the meat, skin, fatty tissue, tendons, cartilage, and innards, can be offered in a product in an advantageous combination.

Within the meaning of the present invention, slaughtered meat refers to the meat of warm-blooded animals that have been killed and/or slaughtered for the purpose of food production. In this case, the use of solid muscle meat with attached and/or incorporated fatty and connective tissue, which is perceived by the consumer to be of higher quality, is preferred.

Within the specification of the present invention ‘reconstituted meat/meat’ designates the claimed combination of a layer of raw reconstituted meat with a layer of sheer, raw meat.

“Adjusting and auxiliary substances and unavoidable accompanying substances” refers to additives and accompanying substances that are common and/or unavoidable as the remainder of a reconstituted meat composition. In many markets, for example, additional final surface disinfection of meat products with a liquid disinfectant is mandatory. Such additives do not alter the nutrient content of a product and are usually contained in a concentration of 1 to 2% or less.

Adjusting substances adjust the properties of a food, and include, for example, UV protective agents or gas-tight container materials that seal a product toward the outside. These substances also do not alter the appearance or nutrient content of a product and are usually added in concentrations of 1 to 2% or less.

Auxiliary substances help to affect product-relevant characteristics such as color, consistency, pore size, taste, and even elasticity; although such substances improve appearance, taste, and customer acceptance, they do not significantly alter the nutrient content and are usually contained in concentrations of 1 to 2% or less.

Finally, unavoidable accompanying substances are trace and vestigial substances that are naturally contained as a result of production in the main components and adjusting and auxiliary substances. A classic example of this are the established indications regarding potential content of nut and soy proteins, which can unintentionally penetrate from parallel production lines via the air in the parts per thousand range into a product produced in parallel. Such trace and vestigial substances are typical in industrial production and are taken into account in the explained description.

Such a “remainder” thus refers to the total amount of common, unavoidable accompanying substances in industrial or commercial production of a food and includes such accompanying substances in a concentration of a few percent, preferably less than 2%, and particularly preferably less than 1%.

As a salt, sodium chloride alone is used, which unlike established salts such as phosphates or nitrates cannot cause any chemical reactions in the product and/or in the digestive tract. In combination, glycerol and salt provide a particular advantage in that in the production phase, the salt dehydrates the edges of the meat segments to a certain extent—in the case of sodium chloride, particularly advantageously, without any chemical redox reaction—while the glycerol retains a portion of the meat juice extracted in this manner and thus ensures juiciness of the raw mass in the form of residual moisture even in the case of excessively lengthy drying times.

A preferable method according to the invention for producing a reconstituted raw piece of meat combined with a raw piece of meat with increased shelf life
is characterized in that the prescribed, reconstituted meat composition is placed on a target meat slice's surface having a uniform layer thickness and dried.

In contrast to the prior art, stabilizing of the shape and preservation take place in a single step, which reduces costs, and in combination with glycerol, provides in a particularly advantageous manner preserved products having an adjustable degree of residual moisture of the meat juice and a precise degree of juiciness.

In a preferable embodiment of the invention, a method is used for producing a raw piece of reconstituted meat/meat is suggested in which
a solid piece of meat is first cut into slices, and
the slices are arranged lying flat, wherein
each of the slices lying flat provides an individual target surface for a reconstituted meat layer.

The meat slice arranged with its outer side visible clearly shows the origin and nature of the processed food; in this case, meat types of the same animal species are therefore preferably processed into a raw piece of reconstituted meat/meat in order to make it possible to optically convey the type of product in a clearer and more definite manner.

The method is preferably characterized in that the layer thickness of the reconstituted meat composition is 0.1 cm to 2 cm, the thickness of the slices is 0.1 cm to 1 cm, and the thickness of the slices is a maximum of 70% of the layer thickness of the reconstituted meat layer. In this manner, multiple portions of the same size and having the same nutritional value can be obtained from a piece of pure meat. Particularly preferably, this makes it possible to obtain from a chicken or poultry fillet about 10 to 20 fillets with a reconstituted meat layer adjacent to their undersides. In this manner, a combined raw piece of reconstituted meat/meat is preferably obtained wherein the meat and shredded meat are composed of poultry, particularly preferably chicken or poultry meat.

The combined raw piece of reconstituted meat/meat is preferably characterized in that the slice of solid meat is arranged therein with its upper side visible, and a laterally enclosing edge ensures an optically uniform transition to the reconstituted meat layer bonded by drying on the underside. This allows a product to be obtained that ensures a highly acceptable appearance as a patty, animal feed, or an animal snack. For animals or consumers requiring higher protein content, animal or plant protein can be optionally added. Particularly preferably, animal protein is used that was obtained from the same animal species used for the shredded meat and the meat slices. Using glycerol as a polyalcohol, the above-described reconstituted meat composition can be advantageously dried to preserve it or can be particularly effectively bonded to the meat slice: the inventors take as a point of departure that the salt, a portion of which is in direct contact with the meat slice, will dehydrate the slice in planar fashion, and that glycerol will penetrate into the meat slice at least at the edges thereof in the area of the contact surface between the reconstituted meat layer and the meat slice. This can suitably explain why the raw piece of reconstituted meat/meat made available in this manner can be bent and deformed like a pure piece of dried meat without the slice becoming detached from the layer.

Further advantages can be seen from the examples. The preferred features and advantages described above and the following examples are not to be understood as limitative. Advantageous or preferred additional features and additional combinations of features, as specified in the description, can be implemented in the claimed subject matter either individually or in combination within the scope of the independent claims without deviating from the scope of patent protection.

### DETAILED DESCRIPTION OF THE INVENTION BY MEANS OF EXAMPLES

In a preferred embodiment, a combined raw piece of reconstituted meat/meat, more particularly a raw piece of meat for animal feed, comprises a layer of a reconstituted meat composition comprising shredded meat and binders, wherein in turn the reconstituted meat composition consists of the components
20 to 90 parts by weight of shredded meat,
0.001 to 20 parts by weight of sodium chloride,
0.01 to 10 parts by weight of glycerol, and
0 to 10 parts by weight of animal or plant protein,
with the remainder comprising adjusting and auxiliary substances and unavoidable accompanying substances of the components, the raw piece of reconstituted meat/meat further comprises at least one slice of solid meat, wherein in turn
the shredded meat and slice of solid meat are composed of chicken or poultry meat,
the layer thickness of the reconstituted meat layer is 0.1 cm to 2 cm, the thickness of the slices is 0.1 cm to 1 cm, and the thickness of the slices is a maximum of 70% of the layer thickness of the reconstituted meat layer,
in the raw piece of reconstituted meat/meat, the at least one slice of solid meat is arranged with its outer side visible, and
the raw piece of reconstituted meat/meat was obtained by preparing the meat slices, combining them with a suitably punched out reconstituted meat layer, optionally applying further slices, and drying.

In a further advantageous embodiment, solid muscle meat, preferably from an outer chicken fillet, is first cut into longitudinal slices measuring 2.5 mm in thickness. For this purpose, the meat is prepared by chilling or freezing in order to ensure improved uniformity of the slices produced at 3±5° C. from the partially solidified tissue. The layer fillet obtained in this manner is composed of approximately 15 to 20 oval slices of identical thickness up to ±0.1 mm, i.e. +−4% uniformity in thickness, with varying diameters. These slices are placed on a conveyor belt.

In parallel to this process, the reconstituted meat is produced according to a predetermined recipe; for this purpose, mechanically obtained poultry tissue having the lowest possible fat content, which because of its content of tendons and cartilage can provide better texture, is preferably used. Frozen blocks of such meat are shredded and then finely minced for 5 minutes with a small amount of salt, preferably 0.002%, and 7% glycerol relative to the mixture. The temperature of the minced mixture is constantly maintained at less than −3° C. Optimum juiciness and reconstitutability are obtained at −3 to −5° C. The mass temperature-controlled in this manner is passed through a reconstituting machine in which the suitable reconstituted fillet pieces are produced.

For this purpose, the fillet slices are analyzed, suitable oval shapes are chosen from a selection of 16 available shapes, and formed reconstituted meat layers are punched out. The shapes are selected so that they correspond to sizes less than or equal to the oval slices of the fillets. The reconstituted meat layers are fed onto a parallel conveyor belt, and the fillet slices are placed on the respective reconstituted meat layers, wherein the individual layer diameters correspond at a maximum to the diameter of the slice; the fillet and/or the reconstituted meat layer is preferably turned such that there is a maximum number of contact points at the edges of the reconstituted meat layer that has been kept smaller or of equal size.

### COMPARATIVE EXAMPLE

A comparative product was prepared, wherein the reconstituted meat was prepared according to prior art, consisting of chicken meat, 14 percent by weight water, 3 percent by weight of egg albumin and 1 percent by weight of carboxymethyl cellulose (the latter two being a binding mixture/established mixture for solidifying raw meat admixtures).

The inventive reconstituted meat/meat product produced in this manner is dried at approximately 50 to 80° C. in a hot-air oven for approx. 18-24 hours to a residual moisture of approx. 10%. In the finished product, both layers are bonded to each other in a stable manner and show no tendency to separate, even when subjected to impact, pressure, or shock stresses in a loosely stacked bag package.

Comparative product was dried likewise; at raised temperatures the binders resulted in a faster drying process, due to enhanced stabilisation of water within a binding matrix; the amount of removable water was thus less, while the product appeared similar in elasticity/hardness.

Comparative product and inventive product were placed—30 pieces each—into respective flat plastic bags of 0.5 L maximum volume. 10 of each plastic bags were placed into cardboard boxes. Each box was dropped from 30 cm height 10 times. Afterwards each box was tumbled slowly in full circly 10 times. Then boxes were opened and bags were poured out from 50 cm height and concludingly arranged in a display shelf for optical inspection and subsequent analysis.

A snack was recorded as ‘broken’ in case of complete separation of reconstituted meat layer from the sheer meat layer;

a snack was recorded as ‘chipped’, in case of visible, complete loss of more than 5% of the reconstituted meat layer (i.e. sheer meat layer was visible);
‘wear debris’, i.e. meat powder accumulating at the bottom of the bag, was recorded as ‘substantial’ in case said powder exceeded the height of 1 cm.

Overview of results is given in the following table:

TABLE 1
comparison of mechanical stability of inventive
products vs. Comparative products:

| Sample | broken snacks | chipped snacks | amount of wear debris |
|---|---|---|---|
| comparative | 3.1 | 10.2 | much; 4 × substantial; |
| invention | 0 | 0.3 | traces; none substantial; |

Inventors attribute inferior performance of established snacks to the added water in combination with the binding agents: Inventors assume water dilutes binding fibers to begin with and then binding agents fix surplus water and binding fibers within their weaker binding network; the resulting snacks seem to be equal in consumption (i.e. chewiness/elasticity) but turn out to be mechanically much more instable in spite of added egg-protein and carboxymethylcellulose. These snacks lose acceptable appearance pretty fast and will not be accepted within the market.

Complementing experiments corroborated the above results: If no additional water is added the combination of glycerol and salt provides surprising stability of the obtainable snacks, improving shelf-life and stability of optical appearance considerably.

### INDUSTRIAL APPLICABILITY

A method for combining a slice of raw meat and a layer of reconstituted raw piece of meat to obtain a combined raw piece of reconstituted meat/meat.

Prior products have been rejected as disadvantageous because: they contain chemical additives such as aminases; they are expensive to produce; they have an inhomogeneous appearance; they tend to separate/disassemble into single components during handling, reducing their shelf-life.

Invention contains only glycerol and salt as binders; stabilizing and preserving are carried out in a single step by drying to a residual moisture of approx. 10%. The raw combination of reconstituted meat/meat has the optical appearance of pure meat, similar elasticity and a precisely adjusted residual juice content. Such a pet food snack can include all types of meat of respective prey animals and shows no tendency to separate, even when subjected to impact, pressure, or shock stresses in a loosely stacked bag package.

1. A method for producing a combination of raw reconstituted meat and raw meat, having increased shelf life in a loosely stacked bag package, wherein
a) a reconstituted meat composition for reconstitutable raw masses, comprising shredded meat and binders, consisting of the components
100 parts by weight of shredded animal meat,
0.1 to 20 parts by weight of sodium chloride,
0.01 to 10 parts by weight of binder consisting of glycerol,
0 to 10 parts by weight of additional plant or animal protein, and
up to 5 parts by weight of adjusting, auxiliary and
unavoidable accompanying substances of the components,
is provided;
b) a solid piece of meat is cut into slices of uniform thickness, the thickness varying +−4%, and
c) the slices are arranged lying flat, wherein
each of the slices lying flat provides an individual target surface for a reconstituted meat layer, wherein
d) the reconstituted meat layer is obtained by applying the meat composition of step a) to the target surface of step c) and
e) drying the combination of reconstituted meat/meat to a residual moisture of approximately 10%.

2. The method as claimed in claim 1, characterized in that the layer thickness of the reconstituted meat composition is 0.1 cm to 2 cm, the thickness of the slices is 0.1 cm to 1 cm, and the thickness of the slices is a maximum of 70% of the layer thickness of the reconstituted meat layer.

3. The method as claimed in claim 1, characterized in that only poultry meat is used as the meat and as the shredded meat.

4. The method as claimed in claim 1, characterized in that only chicken is used as the meat and as the shredded meat.

5. The method as claimed in claim 1, characterized in that in the raw piece of reconstituted meat/meat, the slice of solid meat is arranged with its upper side visible and with a lateral surrounding edge, with the edge thus ensuring an optically uniform transition to the reconstituted meat layer bonded on its underside by drying.
